(19) United States
(12) Patent Application Publication
(10) Pub. No.: US 2025/0077230 A1
(43) Pub. Date: Mar. 6, 2025

(54) NEURAL NETWORK OPERATION INSTRUCTIONS

(71) Applicant: TEXAS INSTRUMENTS INCORPORATED, Dallas, TX (US)

(72) Inventors: Atul Lele, Bangalore (IN); Mahesh Mehendale, Garland, TX (US); Uri Weinrib, Mazkeret Batya (IL); Anurag Choudhury, Faridabad (IN)

(21) Appl. No.: 18/643,336

(22) Filed: Apr. 23, 2024

Related U.S. Application Data
(60) Provisional application No. 63/580,463, filed on Sep. 5, 2023.

(51) Int. Cl. G06F 9/30; G06F 9/38

(52) U.S. Cl. CPC G06F 9/30145; G06F 9/30098; G06F 9/3802

(57) ABSTRACT

Disclosed herein are improvements to instructions and hardware for performing neural network operations. In an embodiment, a processing device includes instruction fetch circuitry, decoder circuitry, and neural network operation circuitry. The instruction fetch circuitry is configured to fetch a neural network instruction from memory that specifies an operation and a set of values that enable sub-circuits of the neural network operation circuitry for use with one or more of the operations of the group of operations and provide the neural network instruction to the decoder circuitry. The decoder circuitry is configured to cause the neural network operation circuitry to perform, based on the operation, a convolution operation using a first sub-circuit of the neural network operation circuitry and a first subset of the set of values or a batch normalization operation using a second sub-circuit of the neural network operation circuitry and a second subset of the set of values.

### CROSS-REFERENCE TO RELATED APPLICATIONS

This application claims the benefit of and priority to U.S. Patent Application No. 63/580,463, filed Sep. 5, 2023, entitled “SHARED HARDWARE FOR DEEP NEURAL NETWORK FUNCTIONS,” which is hereby incorporated herein by reference.

### TECHNICAL FIELD

Aspects of the disclosure are related to the field of computer hardware and software, and to new hardware instructions for neural network computations.

### BACKGROUND

Implementations of deep neural networks (DNNs) may be challenging at Edge nodes such as in low-end, low-cost microcontrollers relative to implementation in high-end processors. The DNNs often include several functions and layers that may each be optimized and implemented differently to produce the best possible trade-off between area, cost, and performance of a DNN.

Two of these functions include convolution functions using Matrix Multiply and Accumulate (MMA) functions and batch normalization. Convolution functions may use binary (1-bit) and ternary weights (2-bit) to reduce the activation storage and increase performance of higher numbers of convolution operations in a single clock cycle. However, to enable such convolution functions (i.e., 16×8 convolution), a DNN may utilize additional resources without yielding improved accuracy relative to 8×8 convolution (i.e. 8-bit data and 8-bit weights/activations). Batch normalization functions refer to operations used to accelerate the training of DNNs. Mathematical operations involved in batch normalization functions include scale (multiply), shift (divide) and clamp (compare between max and min thresholds and saturate to min/max values if input is out of range) operations. Existing DNNs utilize different logic and hardware given the differences in operations used for each type of function.

### SUMMARY

Technology is disclosed herein that provides a low cost, low power, and low latency solution for accelerating functions within a neural network. In various implementations, a neural network instruction is added to an instruction set architecture (ISA) of a CPU to perform either a convolution operation or a batch normalization operation on data, rather than having to offload the operations to multiple hardware accelerators.

In one example implementation, a processing device includes instruction fetch circuitry, decoder circuitry coupled to the instruction fetch circuitry, and neural network operation circuitry coupled to the decoder circuitry. The instruction fetch circuitry is configured to fetch a neural network instruction from memory that specifies an operation and a set of values that enable sub-circuits of the neural network operation circuitry for use with one or more of the operations of the group of operations and provide the neural network instruction to the decoder circuitry. The decoder circuitry is configured to cause the neural network operation circuitry to perform, based on the operation, a convolution operation using a first sub-circuit of the neural network operation circuitry and a first subset of the set of values or a batch normalization operation using a second sub-circuit of the neural network operation circuitry and a second subset of the set of values.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a processing system in an implementation.

FIG. 2 illustrates a method of operating a processing system in an implementation.

FIG. 3 illustrates an operational environment in an implementation.

FIG. 4 illustrates an operational sequence in an implementation.

FIGS. 5A and 5B illustrate an operational architecture in an implementation.

FIG. 6 illustrates a computing system suitable for implementing the various operational environments, architectures, processes, scenarios, and sequences discussed below with respect to the other Figures.

### DETAILED DESCRIPTION

Systems, methods, and devices are disclosed herein which accelerate convolution and batch normalization operations of a neural network without having to offload them to multiple dedicated hardware accelerators. Rather, a neural network instruction is disclosed that may be directly decoded and executed by a CPU using a shared data path to a single circuit for supporting both types of neural network operations. The disclosed technique(s) may be implemented in the context of hardware, software, firmware, or a combination thereof to provide a method of acceleration that reduces the power consumption, cost, and latency of a system that executes convolution and batch normalization operations. In various implementations, a suitable computing system employs neural network operation circuitry via a neural network instruction to execute the convolution and batch normalization operations of a neural network.

In an implementation, the processing circuitry contains multiple data paths through an execution pipeline to execute the operations of a neural network. Each data path may be associated with a set of instructions and a set of operation to be performed on data of the instructions and may include a combination of execution circuitry shared with the execution circuitry of the other data paths and of circuitry distinct from the execution circuitry of the other data paths. For example, the multiple data paths may include an arithmetic logic data path, a floating-point data path, and a neural network operation data path. In operation, a decoder will receive instructions related to the three data paths. In response, the decoder decodes the instruction to identify the appropriate data path to provide the instruction. The decoder also decodes the instruction to identify the location(s) of the data associated with the instruction. For example, the decoder may identify the register addresses of the registers that store the data required to perform the instruction. Once the decoder identifies both the appropriate data path and the register addresses of the data, the decoder provides the register addresses to the appropriate data path.

For example, the decoder may provide the register addresses for registers storing data identified by a neural network instruction to the neural network operation data path. In response, the neural network operation data path performs either a convolution operation or a batch normalization operation on the data identified by the neural network instruction via neural network operation circuitry.

In an embodiment, the neural network operation circuitry of the neural network operation data path includes a plurality of hardware components, such as multiplexers, adders, shifters, flip-flops and latches, and other logic gates and devices. The neural network operation circuitry may be used to perform both convolution operations or batch normalization operations, which may result in improved area and cost savings. In operation, the decoder provides the register location of the data identified by the neural network instruction to the neural network operation data path. In response, the neural network operation data path performs either the convolution operation or the batch normalization operation, based on which operation the neural network instruction specifies, on the data identified by the neural network instruction. To allow the neural network operation circuitry to perform either operation, the neural network instruction specifies the type of operation and a set of values that enable sub-circuits of the neural network operation circuitry for use with the specified operation and the specified data. The output of the operations is sent to one or more destination registers of the processing circuitry, as identified by the neural network instruction.

Results of the neural network operations may be representative of the input to a next node of the network. Meaning, results of the neural network operations may be used as input for a future operation of the neural network. Alternatively, results of the neural network operations may be representative of the overall output of the neural network.

In an embodiment, a processing device includes instruction fetch circuitry, decoder circuitry coupled to the instruction fetch circuitry, and neural network operation circuitry coupled to the decoder circuitry. The instruction fetch circuitry is configured to fetch a neural network instruction from memory that specifies an operation and a set of values that enable sub-circuits of the neural network operation circuitry for use with one or more of the operations of the group of operations and provide the neural network instruction to the decoder circuitry. The decoder circuitry is configured to cause the neural network operation circuitry to perform, based on the operation, a convolution operation using a first sub-circuit of the neural network operation circuitry and a first subset of the set of values or a batch normalization operation using a second sub-circuit of the neural network operation circuitry and a second subset of the set of values.

In another embodiment, an apparatus including a memory device, neural network operation circuitry, decoder circuitry, and instruction fetch circuitry is provided. The memory device is configured to store program instructions. The neural network operation circuitry is configured to perform neural network operations. The decoder circuitry is coupled to the neural network operation circuitry. The instruction fetch circuitry is coupled to the memory device and to the decoder circuitry and is configured to fetch the program instructions from the memory device. The decoder circuitry is configured to cause data identified by the program instructions to be provided to computational circuitry of the apparatus, and, when the program instructions comprise a neural network instruction that specifies an operation of the neural network operations and a set of values that enables sub-circuits of the neural network operation circuitry, the decoder is configured to cause a sub-circuit of the neural network operation circuitry to perform the operation.

In yet another embodiment, one or more computer-readable storage media is provided that includes program instructions stored thereon comprising a neural network instruction that specifies an operation of a group of operations and a set of values that enable sub-circuits of neural network operation circuitry for use with one or more of the operations of the group of operations, wherein the program instructions, when read and executed by a processing system, direct a processor to perform various functions. For example, the program instructions may direct the processor to perform, based on the operation, a convolution operation using a first sub-circuit of the neural network operation circuitry and a first subset of the set of values or a batch normalization operation using a second sub-circuit of the neural network operation circuitry and a second subset of the set of values.

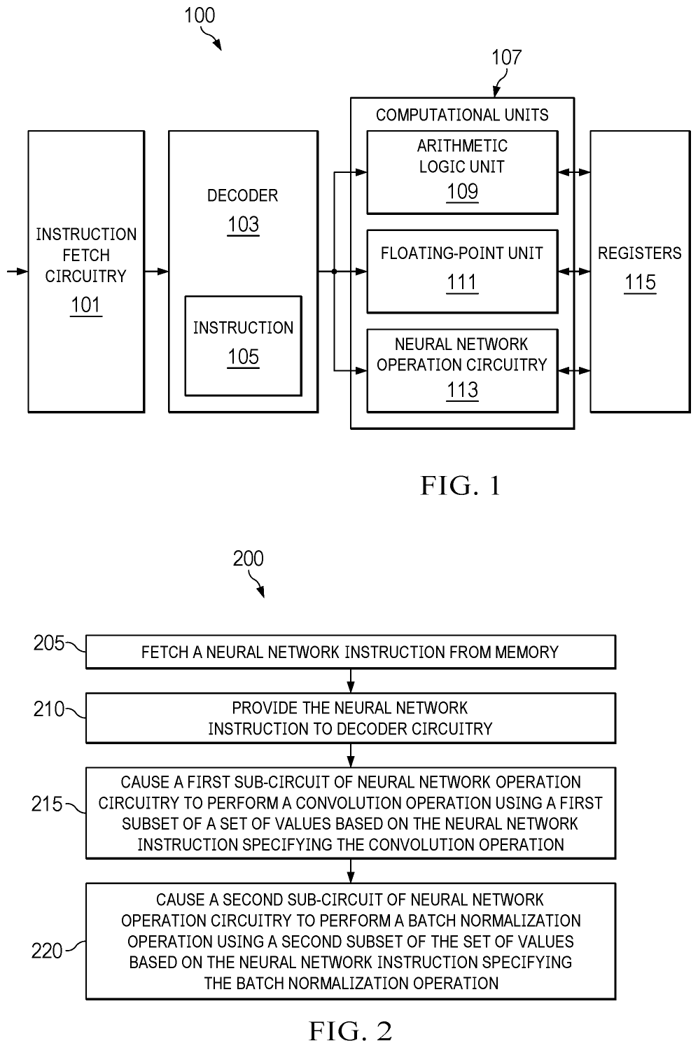

Turning now to the Figures, FIG. 1 illustrates a processing system for executing neural network instructions, herein referred to as processing system 100. Processing system 100 is representative of a processor that may be implemented within a single processing device or distributed across multiple processing devices or sub-systems that cooperate in executing program instructions. Examples of processing system 100 include one or more central processing units. In an implementation, processing system 100 is representative of a modified Arm Cortex M33 core processor. Processing system 100 includes—but is not limited to—instruction fetch circuitry 101, decoder 103, computational units 107, and registers 115. Instruction fetch circuitry 101, decoder 103, computational units 107, and registers 115 may be integrated into a single integrated circuit chip or implemented as multiple interconnected chips. Processing system 100 may be implemented in a larger context, such as, for example, a computer vision system.

Instruction fetch circuitry 101 is representative of circuitry that fetches instructions (e.g., instruction 105), from an associated program memory and provides the instructions to decoder 103. Instruction fetch circuitry 101 may include components such as address and data busses, an instruction cache, and a control unit. Instruction fetch circuitry 101 may include circuitry types such as sequential fetch circuitry, prefetching circuitry, branch prediction circuitry, or trace cache circuitry.

Decoder 103 is representative of a multi-input, multi-output logic circuit that converts coded input into readable output signals. Decoder 103 is coupled to computational units 107 to deliver instructions for a neural network to execute an operation. In an implementation, decoder 103 is also coupled to instruction fetch circuitry 101 to receive instructions related to computational units 107. In operation, decoder 103 receives instruction 105 from instruction fetch circuitry 101 and stores instruction 105 to an instruction buffer. Next, decoder 103 decodes instruction 105 to identify the location of the data (e.g., operands) on which instruction 105 is to operate. In an implementation, instruction 105 specifies one or more register addresses that store the data for performing instruction 105. For example, the data used to perform instruction 105 may be stored in registers 115. Alternatively, data used to perform instruction 105 may be stored in a register file of an off-chip memory.

Instruction 105 also specifies an operation of a group of operations to be performed on the data. Instruction 105 may be representative of three types of operations including an arithmetic logic operation, a floating-point operation, or a neural network operation (e.g., a convolution operation, a batch normalization operation). In an implementation, instruction 105 specifies both the operation to be performed, as well as the registers which store the data. For example, instruction 105 may be representative of a neural network instruction that employs neural network operation circuitry 113 to perform a neural network operation on data stored by registers 115. More specifically, the neural network instruction may specify the operation and corresponding data and also specify a set of values that enable sub-circuits of neural network operation circuitry 113 for use with the operation and the data. The group of operations may include a batch normalization operation and a convolution operation. The convolution operation may include an 8-bit by 8-bit convolution operating using matrix multiple and accumulate (MMA) functions. The batch normalization operation may include a batch normalization operation using scale, shift, and add functions. Each operation may use a sub-circuit of neural network operation circuitry 113.

In an implementation, the registers specified by instruction 105 are representative of the registers that store the input data, the weight data, and the output data. Input data may be representative of data collected by a sensor, such as image data, acoustic data, vibration data, current data, voltage data, or a combination thereof. Alternatively, input data may be representative of computational data produced by hardware and/or software, such as processing data collected by a sensor. Alternatively, input data may be representative of computational data produced by a previous node of the network. Weight data is representative of the weight values applied to the input data by the nodes of the network. Output data is representative of the output produced by computational units 107. As such, instruction 105 identifies the destination register for storing the output data. In an implementation the data identified by instruction 105 is stored by registers 115. In another implementation the data is stored by a memory associated with processing system 100. In operation, decoder 103 identifies the register address(es) of the data for performing instruction 105 and loads the register address(es) of the data to the appropriate computational unit.

Computational units 107 are representative of the different data paths through execution circuitry of the computational units 107 available in a processor for processing data. Computational units 107 include—but are not limited to—arithmetic logic unit (ALU) 109, floating-point unit (FPU) 111, and neural network operation circuitry 113. ALU 109 is representative of a component that executes arithmetic and bitwise operations on fixed-point numbers. ALU includes circuitry configured to perform operations on operands such as simple addition and subtraction, as well as logic operations such as AND and OR. FPU 111 is representative of a component designed to carry out operations on floating point numbers. Example operations include multiply, divide, and square root. Finally, neural network operation circuitry 113 is representative of a component that executes both batch normalization operations and convolution operations on data. In an embodiment, different elements of neural network operation circuitry 113 may be enabled based on which operation is specified by instruction 105. Some elements of neural network operation circuitry 113 may be shared for execution of the batch normalization and convolution operations.

In an implementation, neural network operation circuitry 113 includes circuitry, specifically designed to perform convolution operations and batch normalization operations (collectively referred to as neural network operations). For example, neural network operation circuitry 113 may include one or more sets of multiplexers, multiplier circuits, adder circuits, shifter circuits, sign addition circuits, and clamp circuits, among other circuits and components. In operation, decoder 103 receives an instruction from instruction fetch circuitry 101 for one of the neural network operations, herein referred to as a neural network instruction. The neural network instruction may specify an operation of a group of operations (the neural network operations), register addresses that store data for the operations, and a set of values that enable sub-circuits of neural network operation circuitry 113 for use with one or more of the operations specified.

Decoder 103 decodes the neural network instruction to determine the register addresses that store the data for the neural network operations. For example, the neural network instruction may be indicative of the registers which store data values for the neural network operations. Further, the neural network instruction may be indicative of the address of the destination register to which the output of the neural network operations is loaded. Decoder 103 loads the identified register addresses to neural network operation circuitry 113 to cause neural network operation circuitry 113 to perform either the batch normalization operation or the convolution operation on the data stored by the registers identified by decoder 103.

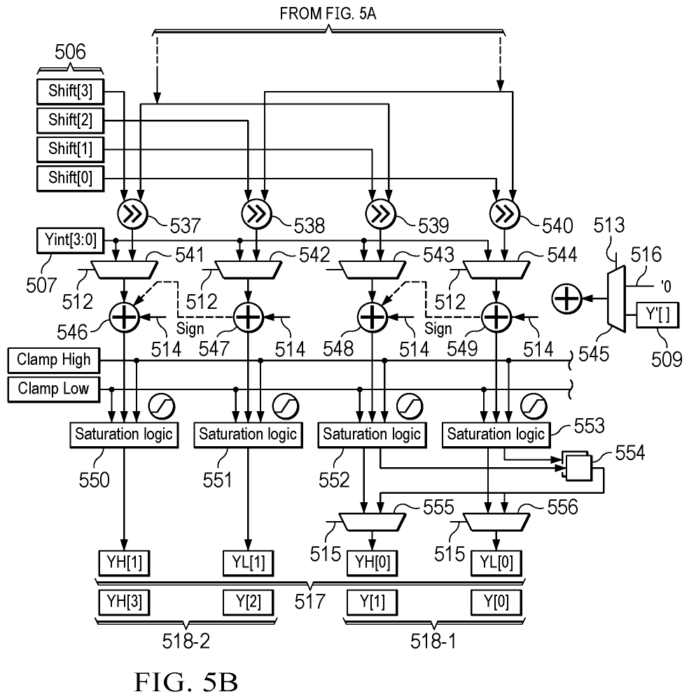

In an example where the neural network instruction specifies the convolution operation, neural network operation circuitry 113 performs the convolution operation via a convolution sub-circuit of neural network operation circuitry 113 and outputs the results to the destination register. Similarly, in an example where the neural network instruction specifies the batch normalization operation, neural network operation circuitry 113 performs the batch normalization operation via a batch normalization sub-circuit of neural network operation circuitry 113 and outputs the results to the destination register. In an implementation, the destination register is located in registers 115. In some examples, the register addresses or locations that store input data associated with the neural network operations may include one or more of a 32-bit register and a 64-bit register, or a combination or variation thereof. Further, the destination register may include a 64-bit register. However, other sizes of registers may be contemplated. Operational architecture 500 of FIGS. 5A and 5B is representative of the neural network operation circuitry, including both the convolution sub-circuit and the batch normalization sub-circuit.

Registers 115 are representative of register files used to store computational data of a neural network. Computational data of registers 115 may include input data collected by an associated system, output data produced by computational units 107, or weight data employed by the neural network.

In operation, decoder 103 receives instruction 105 from instruction fetch circuitry 101 to determine the operation to be performed. Next decoder 103 decodes instruction 105 to identify the registers which store the data. For example, instruction 105 may identify the register addresses for the registers which store the data as well as the destination register that will store the output data. Upon decoding instruction 105, decoder 103 signifies to the appropriate computational unit the register addresses of the data for executing the operation of instruction 105. Instructions related to arithmetic operations are executed by ALU 109. Instructions related to floating-point operations are executed by FPU 111. Instructions related to neural network operations are executed by neural network operation circuitry 113.

Upon receiving the decoded instruction, the corresponding computational unit performs the operation of the decoded instruction. Results of computational units 107 are stored by registers 115. In an implementation, results of the computational units 107 are representative of the input to a next node of a neural network. In another implementation results of computational units 107 represent the overall output of the neural network.

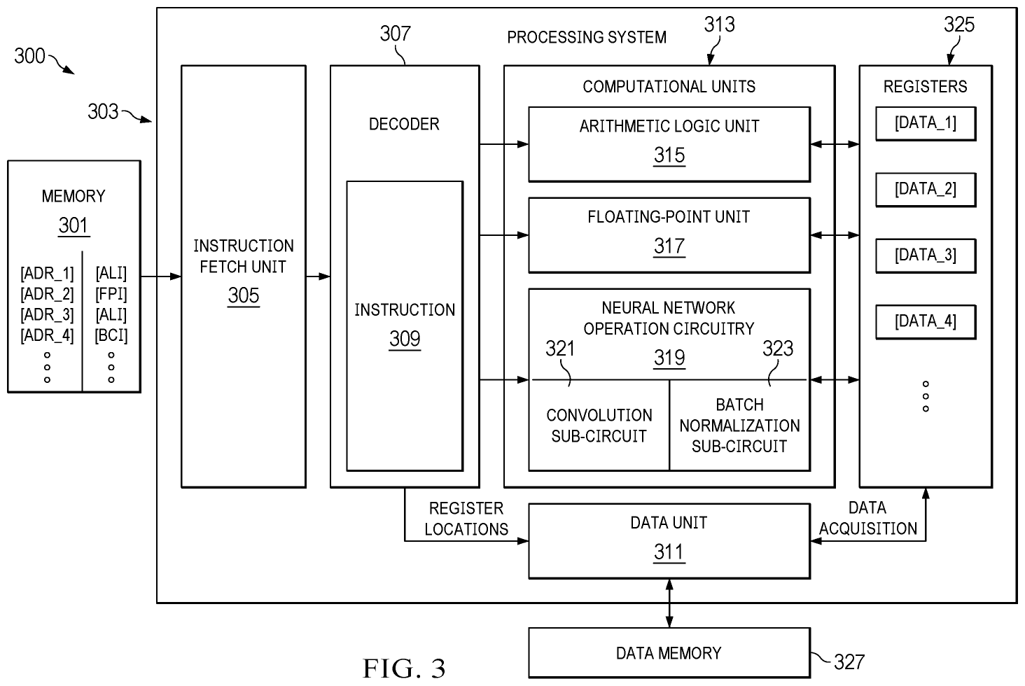

FIG. 2 illustrates a method of operating processing system 100 in an implementation, herein referred to as method 200, which references elements of FIG. 1. In various examples, elements of processing system 100 may perform steps of method 200. Accordingly, method 200 may be implemented in hardware, software, firmware, or combinations or variations thereof.

In operation 205, instruction fetch circuitry 101 fetches instruction 105 from memory. Instruction fetch circuitry 101 may fetch instruction 105 from an on-chip memory or an off-chip memory. In various examples, instruction 105 includes a neural network instruction related to neural network operations. The neural network instruction specifies an operation of a group of operations and specifies a set of values. The group of operations may include a convolution operation and a batch normalization operation. The set of values may specify a location of data on which the operation is to be performed and one or more values that enable a sub-circuit of neural network operation circuitry 113 for use with the operation and the data. The set of values may further specify one or more register addresses corresponding to destination registers that can store outputs from the operation.

In operation 210, instruction fetch circuitry 101 provides instruction 105 to decoder 103. In an example, instruction 105 includes a first subset of values that specifies to decoder 103 that a convolution instruction is to be performed. The first subset of values may specify the convolution operation, locations of data on which the convolution operation is to be performed, and enable values for enabling a convolution sub-circuit of neural network operation circuitry 113 for use with the convolution operation. Based on the first subset of values, decoder 103 may be configured to cause, in operation 215, the convolution sub-circuit to perform the convolution operation. In various examples, decoder 103 may cause the convolution sub-circuit to perform the convolution operation in a single cycle. To perform the convolution operation, the convolution sub-circuit convolves different elements of the data, such as by using matrix multiply and accumulate functions. For example, the data may include input data as well as weight data, such that the input data is convolved with the weight data. The convolution sub-circuit may be directed to perform the convolution operation and store outputs in one or more destination registers of registers 115. In an implementation, data of registers 115 represents input to a next node of the neural network. In another implementation, data of registers 115 represents the overall output of a neural network.

In another example, instruction 105 includes a second subset of values that specifics to decoder 103 that a batch normalization is to be performed. The second subset of values may specify the batch normalization operation, locations of data on which the batch normalization is to be performed (e.g., register operands), and enable values (e.g., selector operands) for enabling a batch normalization sub-circuit of neural network operation circuitry 113 for use with the batch normalization operation. Based on the second subset of values, decoder 103 may be configured to cause, in operation 220, the batch normalization sub-circuit to perform the batch normalization operation. The batch normalization may be directed to perform the batch normalization operation and store outputs in one or more destination register registers of registers 115. Performing the batch normalization operation may include performing shift, scale, and add functions via the batch normalization sub-circuit. In some examples, the locations of data, or sets of register locations, used in the batch normalization operation may include the same, or at least some of the same, locations as those used in the convolution operation. However, in some examples, the register locations used in each operation may be different.

In some examples, decoder 103 may cause the batch normalization sub-circuit to perform the batch normalization operation in two cycles. In the first cycle, decoder 103 may enable a first portion of the batch normalization sub-circuit of neural network operation circuitry 113 based on one of the enable values specified in instruction 105. In the second cycle, decoder 103 may enable a second portion of the batch normalization sub-circuit of neural network operation circuitry 113 based on a different one of the enable values specified in instruction 105. It follows that different components of neural network operation circuitry 113 may be used from cycle to cycle during performance of the batch normalization operation.

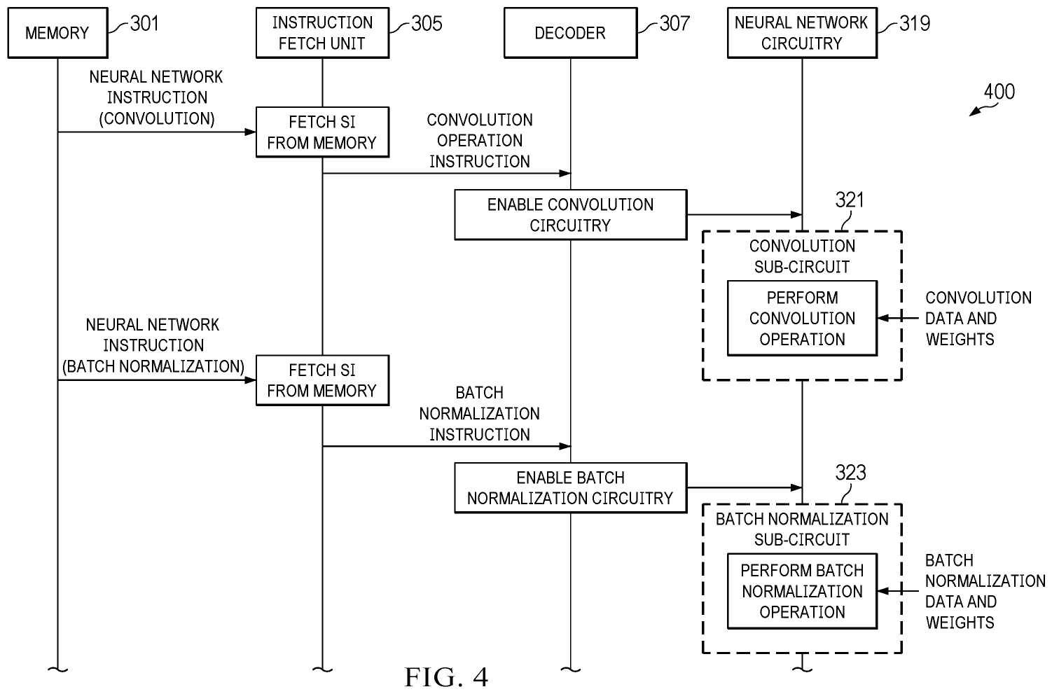

FIG. 3 illustrates an operational environment in an implementation, herein referred to as operational environment 300. Operational environment 300 is representative of a system used in the context of neural networks to execute a task. For example, such tasks may include keyword spotting, voice recognition, object detection, image classification, and so on. Operational environment 300 includes program memory 301, processing system 303, and data memory 327. Operational environment 300 may be implemented in a larger context, such as, any system that utilizes computer vision.

Program memory 301 is representative of an on-chip or off-chip memory accessed by processing system 303. In this case, program memory 301 serves as fast access memory for processing system 303 and is logically coupled to instruction fetch unit 305 to load instructions required by processing system 303 to execute operations of a neural network. Program memory 301 stores instructions related to arithmetic operations, floating-point operations, and neural network operations (e.g., batch normalization operations, convolution operations). Example instructions include arithmetic logic instructions (ALIs), floating-point instructions (FPIs), and neural network instructions (SIs) pertaining to the neural network operations. In an implementation, program memory 301 also stores the register addresses of the data required to perform the operations.

Processing system 303 is representative of a central processing unit capable of executing program instructions. For example, processing system 303 may be representative of processing system 100 of FIG. 1. Processing system 303 includes—but is not limited to—instruction fetch unit 305, decoder 307, data unit 311, computational units 313, and registers 325. In some examples, processing system 303 is an implementation of processing system 100, and instruction fetch unit 305 may be substantially similar to instruction fetch circuitry 101. Decoder 307 may be substantially similar to decoder 103. Computational units 313 may be substantially similar to computational units 107. Registers 325 may be substantially similar to registers 115. Processing system 303 may be implemented within a single processing device but may also be distributed across multiple processing devices or sub-systems that cooperate in executing program instructions.

Instruction fetch unit 305 is representative of circuitry configured to load instructions from program memory 301 to decoder 307. In operation, instruction fetch unit 305 fetches an instruction from program memory 301. For example, instruction fetch unit 305 may fetch instruction 309 from program memory 301. Instruction fetch unit 305 delivers instruction 309 to decoder 307 to begin execution.

Decoder 307 is representative of a logic circuit that converts coded inputs into output signals that are readable by computational units 313. In an implementation, decoder 307 includes an instruction buffer to store instructions loaded from program memory 301. For example, decoder 307 may receive instruction 309 from instruction fetch unit 305. Instruction 309 may be representative of either an ALI, an FPI, or a SI. Decoder 307 decodes instruction 309 to determine the appropriate computational unit for the indicated operation. For example, instruction 309 may be representative of a SI that employs neural network operation circuitry 319 to perform a neural network operation on data stored by registers 325.

In an implementation, decoder 307 also decodes instruction 309 to determine the location of the data for instruction 309. For example, instruction 309 may be indicative of the addresses of the registers (e.g., registers 325) which store the data for the operation of instruction 309. In an implementation, decoder 307 sends the decoded register addresses to data unit 311. In response, data unit 311 allows the appropriate computational unit to access the data.

Data unit 311 is representative of circuitry configured to provide data for computational units 313. Data unit 311 receives the register locations for the data from decoder 307. In response, data unit 311 will allow the appropriate computational unit to access the registers storing the data to begin execution by obtaining the data from either registers 325 or data memory 327, dependent on where the data is stored.

Data memory 327 is representative of an on-chip or off-chip memory accessed by processing system 303 (e.g., a cache). In this case, data memory 327 serves as fast access memory for processing system 303 and is logically coupled to data unit 311. In an implementation, data memory 327 stores the data for performing operations by computational units 313. For example, data memory 327 includes register files which store data that is not stored by registers 325.

Computational units 313 are representative of the different data paths used to execute the instructions of program memory 301. Computational units 313 include arithmetic logic unit (ALU) 315, floating-point unit (FPU) 317, and neural network operation circuitry 319. ALU 315 is representative of a component that executes arithmetic and bitwise operations on binary numbers. ALU 315 includes circuitry configured to perform operations on operands such as simple addition and subtraction, as well as logic operations such as AND and OR. FPU 317 is representative of a component designed to carry out operations on floating point numbers. Example operations include multiply, divide, and square root. Finally, neural network operation circuitry 319 is representative of a component that executes neural network operations, such as convolution operations and batch normalization operations, via convolution sub-circuit 321 and batch normalization sub-circuit 323, respectively, configured to perform respective neural network operations with respect to a SI's operands. The convolution operation may include an 8-bit by 8-bit convolution operating using matrix multiple and accumulate (MMA) functions. The batch normalization operation may include a batch normalization operation using scale, shift, and add functions. Each operation may use a sub-circuit of neural network operation circuitry 113. In an embodiment, different elements of neural network operation circuitry 113 may be enabled based on which operation is specified by instruction 105. Some elements of neural network operation circuitry 113 may be shared for execution of the batch normalization and convolution operations.

In an implementation, neural network operation circuitry 319 includes convolution sub-circuit 321 and batch normalization sub-circuit 323 of which operational architecture 500 of FIGS. 5A and 5B is representative.

Registers 325 represent register files which store computational data of a neural network. Computational data of registers 325 may include input data collected by an associated system, output data produced by computational units 313, or weight data employed by the neural network.

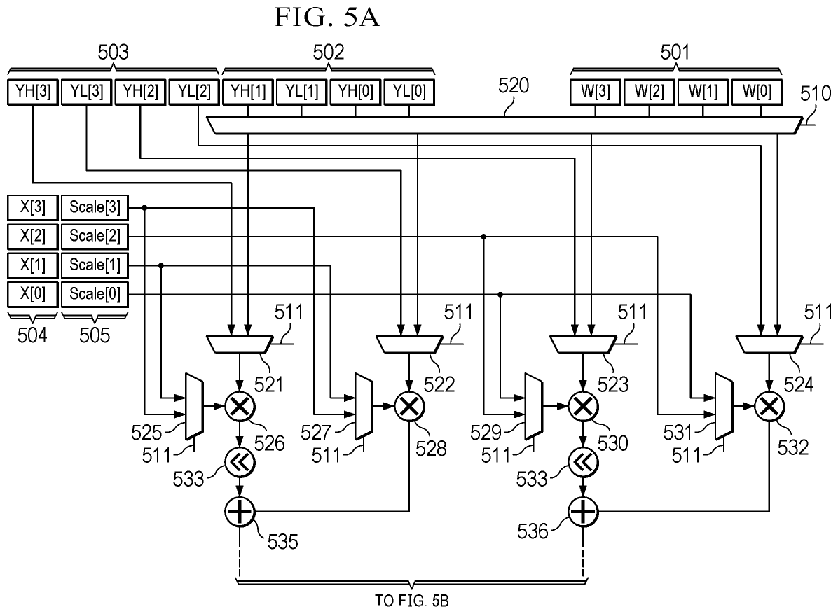

FIG. 4 illustrates an operational sequence for executing different neural network operations from a neural network instruction, herein referred to as operational sequence 400. Operational sequence 400 demonstrates how the components of operational environment 300 execute instructions related to a neural network. Operational sequence 400 includes memory 301, instruction fetch unit 305, decoder 307, and neural network operation circuitry 319.

In operation, instruction fetch unit 305 fetches a program instruction from memory 301 and delivers the instruction to decoder 307. Decoder 307 receives the instruction and decodes the operands and code of the instructions (e.g., operation, register operands, selector operands, opcode) to identify the appropriate computational unit to execute the instruction and to identify the location of the registers for the operation and corresponding data specified in the instruction. The program instruction may include a neural network instruction related to the execution of a neural network operation. The neural network instruction may specify a neural network operation of a group of neural network operations and specify a set of values that enable certain computational units, or sub-circuits thereof, to perform the neural network operation.

In a first example, the neural network instruction specifies a convolution operation and a set of values that enable convolution sub-circuitry of neural network circuitry 319 and that identify one or more registers holding data for use with the convolution operation. Upon decoding the neural network instruction, decoder 307 enables convolution sub-circuit 321 of neural network circuitry 319 and supplies register locations to convolution sub-circuit 321. Upon accessing the data (e.g., convolution data, weight data) from registers 325, convolution sub-circuit 321 performs the convolution operation and generates one or more outputs, which convolution sub-circuit 321 can provide to a destination register of registers 325 to be stored.

In a second example, the neural network instruction specifies a batch normalization operation, a set of values that enable batch normalization sub-circuitry of neural network circuitry 319 and that identify one or more registers holding data for use with the batch normalization operation. Upon decoding the neural network instruction, decoder 307 enables batch normalization sub-circuit 323 of neural network circuitry 319 and supplies register locations to batch normalization sub-circuit 323. Upon accessing the data (e.g., batch normalization data, weight data) from registers 325, batch normalization sub-circuit 323 performs the batch normalization operation and generates one or more outputs, which batch normalization sub-circuit 323 can provide to a destination register of registers 325 to be stored.

FIGS. 5A and 5B illustrate an operating architecture in an implementation. FIGS. 5A and 5B shows operating architecture 500, which is representative of neural network operation circuitry, such as neural network circuitry 113 of FIG. 1 and neural network circuitry 319 of FIG. 3.

Operating architecture 500 includes a plurality of components capable of performing convolution operations and batch normalization operations based on data inputs and enable inputs. An indication of one of the operations, data inputs (or register locations thereof), and enable inputs may be specified by a neural network instruction. The neural network instruction may be provided to a decoder (e.g., decoder 103 of FIG. 1, decoder 307 of FIG. 3) by instruction fetch circuitry (e.g., instruction fetch circuitry 101 of FIG. 1, instruction fetch unit 305 of FIG. 3), decoded by the decoder, and provided to appropriate components of operating architecture 500 (e.g., convolution sub-circuit 321 and/or batch normalization sub-circuit 323 of FIG. 3).

Operating architecture 500 includes multiplexers 520, 521, 522, 523, 524, 525, 527, 529, 531, 541, 542, 543, 544, 545, 555, and 556 (collectively “multiplexers”), multipliers 526, 528, 530, and 532 (collectively “multipliers”), shifters 533, 534, 537, 538, 539, and 540 (collectively “shifters”), adders 535 and 536 (collectively “adders”), sign addition circuits 546, 547, 548, and 549 (collectively “sign addition circuits”), flip-flop circuit 554, and clamp circuits 550, 551, 552, and 553 (collectively “clamp circuits”). The data inputs provided to such components includes convolution weights 501, batch normalization data 502 and 503, convolution data 504, scale inputs 505, shift inputs 506, input data 507, clamp inputs 508, and input data 509. The enable or selection inputs provided to such components include selection inputs 510, 511, 512, 513, 514, and 515. Upon performing neural network operations, components of operating architecture 500 may produce outputs 517, 518-1, and 518-2 (collectively referred to as outputs 518), which may represent inputs or data to another node of a neural network or inputs or data that can be supplied to components of operating architecture 500 in subsequent cycles of neural network operations.

The multiplexers may be representative of circuits configured to receive multiple data inputs and a selection input and provide an output, including one of the data inputs, based on the selection input. The multipliers may be representative of circuits configured to multiply data inputs together to produce an output. The shifters may be representative of circuits configured to shift bits of the data (inputs and/or outputs) to the left (i.e. multiply) or to the right (i.e., divide). In an example, shifters that shift bits to the left may shift most-significant bits. The adders may be representative of circuits configured to add data inputs together to produce an output. The sign addition circuits may be representative of circuits configured to perform signed addition. The flip-flop circuit may be representative of one or more flip-flops or latches configured to store a value of an input. The clamp circuits may be representative of circuits configured to perform saturation logic operations to data to clamp the data and provide an output (i.e., compare between maximum and minimum thresholds and saturate to min/max values if input is out of range). In an embodiment, some of each of these circuits may be enabled and used for performing a convolution operation, while some of each of these circuits may be enabled and used for performing a batch normalization operation. The circuits used for the convolution operation may be referred to as the convolution sub-circuit, and the circuits used for the batch normalization operation may be referred to as the batch normalization sub-circuit. The circuits among the convolution sub-circuit and the batch normalization sub-circuit may overlap. In other words, some circuits used for the convolution operation may also be used for the batch normalization operation, and vice versa, which may advantageously reduce design area requirements and cost as fewer components may be utilized relative to solutions including separate circuitry to perform both types of neural network operations.

Convolution weights 501 may include four weights, denoted by W[0], W[1], W[2], and W[3], each including 8 bits. Batch normalization data 502 and 503 may each include four data inputs, denoted by YL[0], YH[0], YL[1], and YH[1] and YL[2], YH[2], YL[3], and YH[3], respectively, which each may include an 8-bit value. Convolution data 504 may include four data inputs, denoted by X[0], X[1], X[2], and X[3], each including an 8-bit value. Scale inputs 505 may include four scale inputs, denoted by Scale[0], Scale[1], Scale[2], and Scale[3], each including an 8-bit value. Shift inputs 506 may include four shift inputs, denoted by Shift[0], Shift[1], Shift[2], and Shift[3], each including a 5-bit value. Input data 507 may include an input, denoted by Yin [3:0] including a 4-bit value. Clamp inputs 508 may include two clamp inputs, denoted by Clamp Low and Clamp High. Input data 509 may include an input, denoted by Y′[ ] including an 8-bit value. Each of the selection inputs may include a “0” or a “1” and can control operations of a component of operating architecture 500. Output 517 may include four data outputs, denoted by YL[0], YH[0], YL[1], and YH[1], which may each include an 8-bit value. Outputs 518-1 and 518-2 may each include two data outputs, denoted by Y[0] and Y[1] and Y[2] and Y[3], respectively, which may each include a 16-bit value.

In various embodiments, multiplexer 520 may be configured to receive convolution weights 501, batch normalization data 502, and selection input 510 and output values, including values of either convolution weights 501 or batch normalization data 502, to multiplexers 521, 522, 523, and 524 based on the value (e.g., 0, 1) of selection input 510. Multiplexers 521, 522, 523, and 524 may be configured to receive batch normalization data 503, one of convolution weights 501 or batch normalization data 502 (based on selection input 510), and selection input 511. More specifically, multiplexer 521 may receive YH[3] of batch normalization data 503 and either YH[1] or W[3], multiplexer 522 may receive YL[3] of batch normalization data 503 and cither YL[1] or W[2], multiplexer 523 may receive YH[2] of batch normalization data 503 and cither YH[0] or W[1], and multiplexer 524 may receive YL[2] of batch normalization data 503 and cither YL[0] or W[0]. Multiplexers 521, 522, 523, and 524 can output values, including values of convolution weights 501, batch normalization data 502, or batch normalization data 503, to multipliers 526, 528, 530, and 532, respectively, based on selection input 511. For matrix multiply and accumulate (MMA) operations (e.g., convolution operations), multiplexers 521, 522, 523, and 524 output W[3], W[2], W[1], and W[0], respectively, as described further below. For batch normalization operations, multiplexers 521, 522, 523, and 524 output YH[1], YL[1], YH[0], and YL[0], respectively, during a first execution cycle and YH[3], YL[3], YH[2], and YL[2], respectively, during a second execution cycle, as described further below.

Multiplexers 525, 527, 529, and 531 may also be coupled to provide outputs to multipliers 526, 528, 530, and 532, respectively, based on selection input 511. Multiplexers 525, 527, 529, and 531 may be configured to receive convolution data 504, scale inputs 505, and selection input 511. Multiplexers 525, 527, 529, and 531 can output values, including values of convolution data 504 or scale inputs 505, to multipliers 526, 528, 530, and 532 based on selection input 511.

More specifically, multiplexer 525 may receive X[3] or Scale[3] and X[1] or Scale[1], multiplexer 526 may receive X[3] or Scale[3] and X[1] or Scale[1], multiplexer 527 may receive X[2] or Scale[2] and X[0] or Scale[0], and multiplexer 528 may receive X[2] or Scale[2] and X[0] or Scale[0]. For MMA operations, multiplexer 525, 527, 529, and 531 output X[3], X[1], X[2], and X[0], respectively, as described further below. For batch normalization operations, multiplexers 525, 527, 529, and 531 output Scale[3], Scale[3], Scale[2], and Scale[2], respectively, during a first execution cycle and Scale[1], Scale[1], Scale[0], and Scale[0], respectively, during a second execution cycle, as described further below. Multipliers 526, 528, 530, and 532 can multiply the inputs received together and each produce an output. Multiplier 526 may be coupled to provide an output to shifter 533, multiplier 528 may be coupled to provide an output to adder 535, multiplier 530 may be coupled to provide an output to shifter 534, and multiplier 532 may be coupled to provide an output to adder 536.

Adder 535 may be coupled to provide an output to shifters 537 and 539, and adder 536 may be coupled to provide an output to shifters 538 and 540. Shifters 537, 538, 539, and 540 may also be coupled to receive one of shift inputs 506. Specifically, shifter 537 may be coupled to receive Shift[3], shifter 538 may be coupled to receive Shift[2], shifter 539 may be coupled to receive Shift[1], and shifter 540 may be coupled to receive Shift[0]. Upon performing a shift operation, such as during a batch normalization operation, shifters 537, 538, 539, and 540 may be coupled to provide outputs to multiplexers 541, 542, 543, and 544, respectively.

Multiplexers 541, 542, 543, and 544 may also be configured to receive input data 507 and selection input 512. Multiplexers 541, 542, 543, and 544 can be configured to provide outputs to sign addition circuits 546, 547, 548, and 549, respectively, based on selection input 512. Sign addition circuits 546, 547, 548, and 549 may be configured to perform a sign addition operation on the received outputs based on selection input 514. Sign addition circuits 546, 547, 548, and 549 may each receive selection input 514 from multiplexer 545. Multiplexer 545 may be configured to receive input data 509, input data 516, and selection input 513, and output selection input 514, including a value of either input data 509 or input data 516, based on selection input 513. Sign addition circuits 546, 547, 548, and 549 may be coupled to provide outputs to clamp circuits 550, 551, 552, and 553, respectively.

Clamp circuits 550, 551, 552, and 553 may be configured to receive the outputs from sign addition circuits 546, 547, 548, and 549 and clamp inputs 508, perform a clamp or saturation operation on the inputs to produce outputs. Clamp circuit 550 may be coupled to provide a first output of outputs 517 (YH[1]), clamp circuit 551 may be coupled to provide a second output of outputs 517 (YL[1]), clamp circuit 552 may be coupled to provide a third output (YH[0]) to multiplexer 555 and to flip-flop circuit 554, and clamp circuit 553 may be coupled to provide a fourth output (YL[0]) to multiplexer 556 and to flip-flop circuit 554. Flip-flop circuit 554 may be configured to store output values during one cycle for use in another cycle during a batch normalization operation, for example. Flip-flop circuit 554 can provide stored values to multiplexers 555 and 556. Multiplexers 555 and 556 may be configured to receive the stored values and selection input 515 and output values for YH[0] and YL[0], respectively, based on selection input 515. In some examples, however, such as during a convolution operation, clamp circuits 550, 551, 552, and 553, may provide outputs 518-1 and 518-2.

In operation, when caused to perform a convolution operation by a decoder, multiplexer 520 may receive selection input 510 having a value of “0”, which may cause multiplexer 520 to output convolution weights 501 to multiplexers 521, 522, 523, and 524. Multiplexers 521, 522, 523, and 524 may receive selection input 511 having a value of “0”, which may cause multiplexers 521, 522, 523, and 524 to output convolution weights 501 to multipliers 526, 528, 530, and 532. Multiplexers 525, 527, 529, and 531 may also receive selection input 511 with the value of “0”, which may cause multiplexers 525, 527, 529, and 531 to multiply convolution weights 501 with convolution data 504. In an embodiment, when caused to perform the convolution operation, shifters 537, 538, 539, and 540 may be disabled, or in other words, might not perform a shift operation on inputs provided by adders 525 and 536. Multiplexers 541, 542, 543, and 544 may receive selection input 512 having a value of “1”, which may cause multiplexers 541, 542, 543, and 544 to output input data 507 to adders 546, 547, 548, and 549. Sign addition circuits 546, 547, 548, and 549 may receive selection input 514 having a value of input data 509 based on selection input 513 having a value of “1”. In an embodiment, when caused to perform an 8×8 convolution operation, clamp circuits 550, 551, 552, and 553 as well as flip-flop circuit 554, multiplexer 555, and multiplexer 556 may be disabled or otherwise bypassed. Accordingly, sign addition circuits 546, 547, 548, and 549 may provide outputs 517 that include 8-bit values. In an embodiment, when caused to perform a 16×8 convolution operation, clamp circuits 550, 551, 552, and 553 may be enabled to produce outputs 518-1 and 518-2 that each include 16-bit values.

In operation, when caused to perform a batch normalization operation by a decoder, multiplexer 520 may receive selection input 510 having a value of “1”, which may cause multiplexer 520 to output batch normalization data 502 to multiplexers 521, 522, 523, and 524. Multiplexers 521, 522, 523, and 524 may receive selection input 511 having a value of “1”, which may cause multiplexers 521, 522, 523, and 524 to output batch normalization data 502 to multipliers 526, 528, 530, and 532 during a first cycle and batch normalization data 503 in a second cycle. Multiplexers 525, 527, 529, and 531 may also receive selection input 511 with the value of “1”, which may cause multiplexers 525, 527, 529, and 531 to multiply batch normalization data 502 with scale inputs 505 during the first cycle and batch normalization data 503 with scale inputs 505 during the second cycle. During the batch normalization operation, shifters 533 and 534 may be configured to shift values output by multipliers 526 and 530, respectively, by 8 bits to the left. However, shifts of other values may be contemplated. Shifters 537, 538, 539, and 540 may perform a further shift based on shift inputs 506. Multiplexers 541, 542, 543, and 544 may receive selection input 512 having a value of “0”, which may cause multiplexers 541, 542, 543, and 544 to output the shifted values to sign addition circuits 546, 547, 548, and 549, respectively. Multiplexer 545 may receive selection input 513 having a value of “0”, which may cause multiplexer 545 to output a value of input data 516 (“0”) to sign addition circuits 546, 547, 548, and 549. Next, during the first cycle of the batch normalization operation, flip-flop circuit 554 may store outputs from clamp circuits 552 and 553 (YL[0] and YL[1], respectively) and provide the outputs to multiplexers 555 and 556. Multiplexers 555 and 556 may receive selection input 515 having a value of “1”, which may cause multiplexers 555 and 556 to output outputs 517.

It follows that different elements of operating architecture 500 may be disabled or enabled based on the neural network instruction, and which operation and set of values are specified by the neural network instruction. Other variations or combinations of elements may be contemplated to perform convolution and batch normalization operations using operating architecture 500.

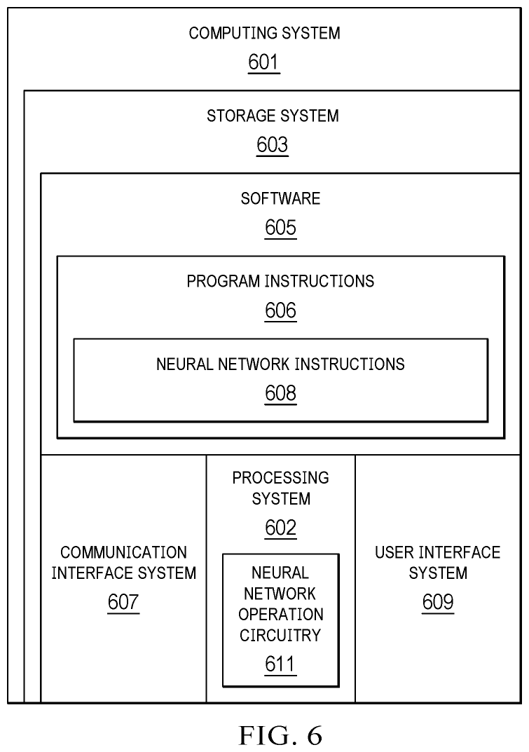

The foregoing implementations may be implemented in the context of a variety of computing devices including—but not limited to—embedded computing devices, industrial computers, personal computers, server computers, automotive computers, MCUs, and the like. As such, the technology disclosed herein also contemplates software products produced by compilers capable of generating neural network instructions as disclosed herein. That is, the technology disclosed herein includes compiled software programs having neural network instructions related to neural network operations amongst their program instructions. FIG. 6 illustrates computing device 601, which is representative of such computers.

Computing device 601 may be implemented as a single apparatus, system, or device or may be implemented in a distributed manner as multiple apparatuses, systems, or devices. Computing device 601 includes, but is not limited to, processing system 602, storage system 603, software 605, communication interface system 607, and user interface system 609 (optional). Processing system 602 is operatively coupled to storage system 603, communication interface system 607, and user interface system 609.

Processing system 602 loads and executes software 605 from storage system 603. Software 605 includes program instructions 606, which includes neural network instructions 608. When executed by processing system 602, software 605 directs processing system 602 to operate as described herein for at least the various processes, operational scenarios, and sequences discussed in the foregoing implementations. Computing device 601 may optionally include additional devices, features, or functions not discussed for purposes of brevity.

Referring still to FIG. 6, processing system 602 may comprise a micro-processor and other circuitry, such as neural network operation circuitry 611, that retrieves and executes software 605 from storage system 603. Processing system 602 may be implemented within a single processing device but may also be distributed across multiple processing devices or sub-systems that cooperate in executing program instructions. Examples of processing system 602 include one or more general purpose central processing units, graphical processing units, microprocessors, digital signal processors, field-programmable gate arrays, application specific processors, processing circuitry, analog circuitry, digital circuitry, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device but may also be implemented across multiple storage devices or sub-systems co-located or distributed relative to each other. Storage system 603 may comprise additional elements, such as a controller, capable of communicating with processing system 602 or possibly other systems.

Software 605 is implemented in program instructions 606 and among other functions may, when executed by processing system 602, direct processing system 602 to operate as described with respect to the various operational scenarios, sequences, and processes illustrated herein. In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtualization software, or other application software. Software 605 may also comprise firmware or some other form of machine-readable processing instructions executable by processing system 602.

In general, software 605 may, when loaded into processing system 602 and executed, transform a suitable apparatus, system, or device (of which computing device 601 is representative) overall from a general-purpose computing system into a special-purpose computing system customized to support neural network operations, such as batch normalization operations and convolution operations. Indeed, encoding software 605 (and neural network instructions 608) on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary, etc.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

Aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A processing device, comprising:
instruction fetch circuitry;
decoder circuitry coupled to the instruction fetch circuitry; and
neural network operation circuitry coupled to the decoder circuitry;
wherein the instruction fetch circuitry is configured to:
fetch a neural network instruction from a memory, wherein the neural network instruction specifies:
an operation of a group of operations; and
a set of data; and
provide the neural network instruction to the decoder circuitry; and
wherein the decoder circuitry is configured to cause the neural network operation circuitry to perform, based on the operation, a convolution operation using a first sub-circuit of the neural network operation circuitry and the set of data or a batch normalization operation using a second sub-circuit of the neural network operation circuitry and the set of data.

2. The processing device of claim 1, wherein the neural network instruction specifies the set of data by specifying register operands and a selector operand.

3. The processing device of claim 2, wherein:
the register operands correspond to register locations; and
the register locations comprise locations for input data registers, weight data registers, and destination data registers.

4. The processing device of claim 3, wherein the decoder circuitry is further configured to:
provide a first set of register locations to the neural network operation circuitry based on the neural network instruction specifying the convolution operation; and
provide a second set of register locations to the neural network operation circuitry based on the neural network instruction specifying the batch normalization operation.

5. The processing device of claim 2, wherein the selector operand specifies a first value based on the operation being the convolution operation and a second value based on the operation being the batch normalization operation.

6. The processing device of claim 1, wherein the decoder circuitry is configured to cause the neural network operation circuitry to perform the convolution operation using the first sub-circuit of the neural network operation circuitry in a single cycle.

7. The processing device of claim 1, wherein the decoder circuitry is configured to cause the neural network operation circuitry to perform the batch normalization operation using the second sub-circuit of the neural network operation circuitry in two cycles.

8. The processing device of claim 1, wherein the neural network operation circuitry comprises a set of multiplexers, a set of multiplier circuits, a set of adder circuits, a set of shifter circuits, a set of sign addition circuits, and a set of clamp circuits.

9. An apparatus, comprising:
a memory device configured to store program instructions;
neural network operation circuitry configured to perform neural network operations;
decoder circuitry coupled to the neural network operation circuitry; and
instruction fetch circuitry coupled to the memory device and to the decoder circuitry and configured to fetch the program instructions from the memory device; and
wherein, when the program instructions comprise a neural network instruction that specifies an operation of the neural network operations and a set of data, wherein the decoder is configured to cause a sub-circuit of the neural network operation circuitry to perform the operation using the set of data.

10. The apparatus of claim 9, wherein the neural network operations comprise a convolution operation and a batch normalization operation.

11. The apparatus of claim 10, wherein the neural network instruction specifies the set of data by specifying register operands and a selector operand.

12. The apparatus of claim 11, wherein:
the register operands correspond to register locations;
the register locations comprise locations for input data registers, weight data registers, and destination data registers; and
the selector operand specifies a first value based on the operation being the convolution operation and a second value based on the operation being the batch normalization operation.

13. The apparatus of claim 12, wherein, when the neural network instruction specifies the convolution operation, the decoder circuitry is configured to cause a first sub-circuit of the neural network operation circuitry to perform the convolution operation using a first subset of the set of values.

14. The apparatus of claim 13, wherein to cause the first sub-circuit of the neural network operation circuitry to perform the convolution operation using the first subset of the set of values, the decoder circuitry is configured to provide a first set of register locations and the first value specified by the selector operand to the first sub-circuit.

15. The apparatus of claim 12, wherein, when the neural network instruction specifies the batch normalization circuitry, the decoder circuitry is configured to cause a second sub-circuit of the neural network operation circuitry to perform the batch normalization circuitry using a second subset of the set of values.

16. The apparatus of claim 15, wherein to cause the second sub-circuit of the neural network operation circuitry to perform the batch normalization operation using the second subset of the set of values, the decoder circuitry is configured to provide a second set of register locations and the second value specified by the selector operand to the second sub-circuit.

17. One or more computer-readable storage media, comprising:
program instructions stored thereon comprising a neural network instruction that specifies an operation of a group of operations and a set of data, wherein the program instructions, when read and executed by a processing system, direct a processor to:
perform, based on the operation, a convolution operation using a first sub-circuit of the neural network operation circuitry and the set of data or a batch normalization operation using a second sub-circuit of the neural network operation circuitry and the set of data.

18. The one or more computer-readable storage media of claim 17, wherein the set of values comprises register operands and a selector operand.

19. The one or more computer-readable storage media of claim 18, wherein:
the register operands correspond to register locations;
the register locations comprise locations for input data registers, weight data registers, and destination data registers; and
the selector operand specifies a first value based on the operation being the convolution operation and a second value based on the operation being the batch normalization operation.

20. The one or more computer-readable storage media of claim 17, wherein the program instructions direct the processor to perform the convolution operation in a single cycle and the batch normalization operation in two cycles.
